(19) United States
(12) Patent Application Publication
(10) Pub. No.: US 2016/0042343 A1
(43) Pub. Date: Feb. 11, 2016

(54) INFORMATION PROCESSING APPARATUS, INFORMATION PROCESSING METHOD AND INFORMATION PROCESSING PROGRAM

(71) Applicant: RAKUTEN, INC., Shinagawa-ku, Tokyo (JP)

(72) Inventor: Hideaki TOBINAI, Shinagawa-ku (JP)

(73) Assignee: Rakuten, Inc., Shinagawa-ku, Tokyo (JP)

(21) Appl. No.: 14/371,016

(22) PCT Filed: Apr. 30, 2013
(86) PCT No.: PCT/JP2013/062659

§ 371 Date: Jul. 8, 2014

(51) Int. Cl. G06Q 20/34; G06Q 20/28

(52) U.S. Cl. CPC G06Q 20/348; G06Q 20/28

(57) ABSTRACT

An information processing apparatus according to one embodiment includes a saving unit and a providing unit. In response to receiving a request for a payment agent in a commercial transaction from a terminal of a user not having a credit card, the saving unit saves available points of the user equivalent to a payment amount of the commercial transaction from a point storage unit. The providing unit acquires a card number of a prepaid payment means usable like a credit card and sets a limit amount based on the available points saved by the saving unit, and thereby provides card information of the prepaid payment means containing the card number and the limit amount for payment of the commercial transaction.

### TECHNICAL FIELD

One aspect of the present invention relates to a device, a method and a program that implement a payment agent in an electronic commerce transaction.

### BACKGROUND ART

There have been shops that require payment with a credit card, particularly online. When conducting a transaction with such a shop and making payment, a user needs to provide the shop with information of the user's own credit card (a card number, a name, an expiration date, a security code etc.) as payment related information.

For such transactions, a mechanism for making payment with a credit card on behalf of a user is known. For example, a credit payment agent server that allows payment at many shops regardless of a specified payment means only by registering with a payment service agency for membership is disclosed in the following Patent Literature 1. This server includes a means of transmitting screen information prompting entry of a request for credit payment and entry of a site selection to a client in response to an access from the client, a relay means of relaying a site screen of a creditor in the credit payment to the client in response to a site selection entry from the client, and a transfer means of transferring a payment number that can be used for the credit payment to the site screen in response to the request entry from the client.

### CITATION LIST

### Patent Literature

PTL 1: JP 2002-133334 A

### SUMMARY OF INVENTION

### Technical Problem

However, in the mechanism of the above Patent Literature 1, payment related information (debt notification information) that can be used also for payment of another transaction is provided to a user terminal. Even in the case of not displaying payment related information on a display screen of a user terminal or issuing one-time payment related information (credit card number), payment related information is still provided to a user terminal. Thus, there is a possibility that the payment related information provided to the user terminal is used for payment of a transaction not assumed by a payment service provider, causing the occurrence of a loss.

Accordingly, in a payment service that receives money to be paid from a user to a shop from the user and pays it to the shop, it is desirable to reduce the risk that the service provider suffers an accidental loss.

### Solution to Problem

An information processing apparatus according to one aspect of the present invention includes a saving unit configured to save a value equivalent to a payment amount related to a commercial transaction before the commercial transaction is settled in association with an agent request from a user terminal that provides information necessary to settle the commercial transaction to an order receiving processing device, and a value specifying data providing unit configured to provide value specifying data for specifying the saved value as payment related information for specifying a payment means for paying the payment amount related to the commercial transaction to the order receiving processing device through the user terminal.

An information processing method according to one aspect of the present invention includes a saving step of saving a value equivalent to a payment amount related to a commercial transaction before the commercial transaction is settled in association with an agent request from a user terminal that provides information necessary to settle the commercial transaction to an order receiving processing device, and a value specifying data providing step of providing value specifying data for specifying the saved value as payment related information for specifying a payment means for paying the payment amount related to the commercial transaction to the order receiving processing device through the user terminal.

An information processing program according to one aspect of the present invention causes a computer to implement a saving unit configured to save a value equivalent to a payment amount related to a commercial transaction before the commercial transaction is settled in association with an agent request from a user terminal that provides information necessary to settle the commercial transaction to an order receiving processing device, and a value specifying data providing unit configured to provide value specifying data for specifying the saved value as payment related information for specifying a payment means for paying the payment amount related to the commercial transaction to the order receiving processing device through the user terminal.

A computer-readable recording medium according to one aspect of the present invention stores an information processing program causing a computer to implement a saving unit configured to save a value equivalent to a payment amount related to a commercial transaction before the commercial transaction is settled in association with an agent request from a user terminal that provides information necessary to settle the commercial transaction to an order receiving processing device, and a value specifying data providing unit configured to provide value specifying data for specifying the saved value as payment related information for specifying a payment means for paying the payment amount related to the commercial transaction to the order receiving processing device through the user terminal.

In the above aspect, because the value equivalent to the payment amount of a commercial transaction is saved, a provider of the payment service can pay the saved value to an administrator (shop) of the order receiving processing device. Accordingly, in the payment service that receives money to be paid from a user to a shop from the user and pays it to the shop, it is possible to reduce the risk on the service provider.

The information processing apparatus according to another aspect may further include a first recording unit configured to acquire ID information of a prepaid payment means usable like a credit card at a member shop of the credit card, the ID information being in the same format as a card number of the credit card, and store the ID information and the value specifying data in association with each other into a storage unit, and an ID information providing unit configured to provide ID information stored or to be stored in the storage unit in association with the value specifying data to the order receiving processing device when receiving the value specifying data from the order receiving processing device.

In the information processing apparatus according to another aspect, the value specifying data may be a dummy number in the same format as the card number and different from the ID information, and the information processing apparatus may further include a second recording unit configured to cause a payment processing device to store the dummy number as a number usable only once.

In the information processing apparatus according to another aspect, the value specifying data may contain the dummy number assigned for each order receiving processing device and attached information set for each commercial transaction.

In the information processing apparatus according to another aspect, the value specifying data providing unit may cause the user terminal to automatically insert the dummy number and the attached information into a specified entry field located on a web page for entering the payment related information to be provided to the order receiving processing device.

In the information processing apparatus according to another aspect, the value specifying data may be payment status information indicating that the value equivalent to the payment amount of the commercial transaction is saved, and the value specifying data providing unit may cause the user terminal to store the payment status information into a terminal storage unit configured to store information to be transmitted to the order receiving processing device.

In the information processing apparatus according to another aspect, the value specifying data providing unit may cause the user terminal to disable a specified entry field located on a web page for entering payment related information to be provided to the order receiving processing device.

In the information processing apparatus according to another aspect, the ID information providing unit may acquire the ID information after receiving the value specifying data from the order receiving processing device.

The information processing apparatus according to another aspect may further include an acquisition unit configured to acquire ID information of a prepaid payment means usable like a credit card only once within a range of the saved value at a member shop of the credit card, the ID information being in the same format as a card number of the credit card, and the value specifying data may be ID information acquired by the acquisition unit.

### Advantageous Effects of Invention

According to one aspect of the present invention, in a payment service that receives money to be paid from a user to a shop from the user and pays it to the shop, it is possible to reduce the risk that the service provider suffers an accidental loss.

### BRIEF DESCRIPTION OF DRAWINGS

FIG. 1 is a diagram showing an overall configuration of an electronic commerce system (EC system) according to an embodiment.

FIG. 2 is a diagram showing a hardware configuration of a payment agent server shown in FIG. 1.

FIG. 3 is a diagram showing a functional configuration of the payment agent server shown in FIG. 1.

FIG. 4 is a sequence chart showing an operation of an EC system according to a first embodiment.

FIG. 5 is a sequence chart showing an operation of the EC system according to the first embodiment.

FIG. 6 is a sequence chart showing an operation of an EC system according to a second embodiment.

FIG. 7 is a sequence chart showing an operation of the EC system according to the second embodiment.

FIG. 8 is a sequence chart showing an operation of an EC system according to a third embodiment.

FIG. 9 is a sequence chart showing an operation of the EC system according to the third embodiment.

FIG. 10 is a diagram showing a configuration of an information processing program according to an embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

### First Embodiment

An electronic commerce system (EC system) 1 according to a first embodiment is described hereinafter. The EC system 1 is a computer system provided with a mechanism that allows a user who does not own a credit card to perform a commercial transaction on an online shopping site (EC site) requiring credit payment.

A user selects a desired item on an online shopping site and performs a payment procedure. Because payment with a credit card is required in this site, the user cannot complete a purchase procedure if not having a credit card in ordinary circumstances. However, in this embodiment, a user who does not have a credit card selects a credit payment agent (which is referred to hereinafter as “payment agent”) on the site and acquires information of a virtual prepaid card from a payment agent company. The virtual prepaid card is a prepaid payment means that uses the scheme of a credit card, and it is defined by the same card number and attached information (an expiration date and a security code) as a credit card. By using the card information, the user can purchase an item on the site just like a credit card holder. The payment agent company provides a settlement service (payment agent service) that receives money to be paid from a user to a shop from the user and pays it to the shop.

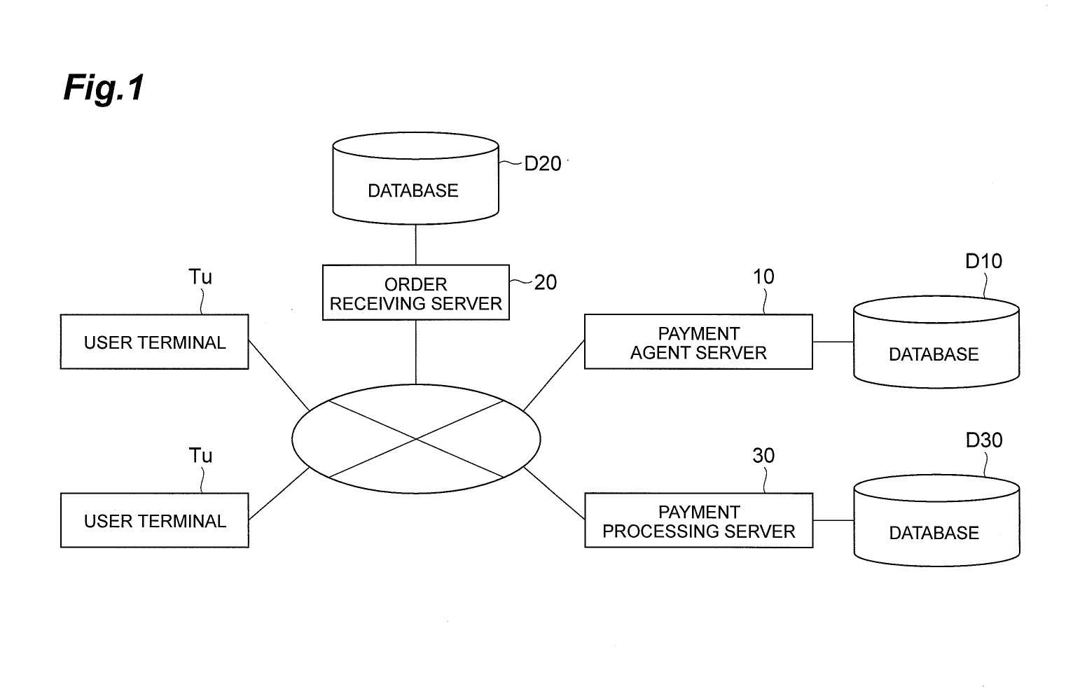

As shown in FIG. 1, the EC system 1 includes user terminals Tu, a payment agent server (information processing apparatus) 10, an order receiving server (order receiving processing device) 20, and a payment processing server (payment processing device) 30. Those servers 10, 20 and 30 work with corresponding databases (storage devices) D10, D20 and D30, respectively.

The user terminals Tu, the payment agent server 10 and the order receiving server 20 are connected with one another through a network such as the Internet. The payment agent server 10, the order receiving server 20 and the payment processing server 30 are connected with one another through a network such as the Internet or a private line. The payment agent server 10 can directly or indirectly access the database D10 through a network such as the Internet or a private line. The order receiving server 20 can directly or indirectly access the database D20 through such a network. The payment processing server 30 can directly or indirectly access the database D30 through such a network. Each of the databases D10, D20 and D30 may be composed of a plurality of storage devices having the function of maintaining synchronization with each other. Note that the number of user terminals Tu and the servers in the EC system 1 is not limited.

The user terminal Tu is a terminal that is used by a user of an online shopping site. The user terminal Tu transmits an HTTP request to the order receiving server 20 in response to a user operation for purchasing an item and displays various kinds of web pages (HTTP responses) transmitted from the order receiving server 20 in response to the request on its display. The user terminal Tu acquires information necessary for payment processing by communicating with the payment agent server 10 during a purchase procedure, and processing related to the payment agent is described later. The variety of the user terminals Tu is not particularly limited, and it may be a stationary or portable personal computer, or a mobile terminal such as an advanced mobile phone (smart phone), a cellular phone or a personal digital assistant (PDA), for example.

The order receiving server 20 is a computer that provides an online shopping site to a user. An administrator of the order receiving server 20 may be each shop or a manager of an online shopping mall. The order receiving server 20 reads a web page of the site from the database D20 in response to the HTTP request from the user terminal Tu and transmits the page to the user terminal Tu. For example, the order receiving server 20 provides an item page, a shopping cart page, a payment procedure page (payment page), a page for confirming a purchase (confirmation page) and the like to the user terminal Tu, though the web page provided to the user terminal Tu is not limited thereto.

The payment page is a web page for transmitting payment related information for specifying a payment means of a commercial transaction from the user terminal Tu to the order receiving server 20. The payment page has a user interface for prompting a user to select whether to pay with a credit card or request a payment agent. The interface can be implemented by JavaScript (trademark or registered trademark), for example, though not limited thereto.

The payment processing server 30 is a computer that performs payment with a credit card or a virtual prepaid card, and it is administered by a credit company. The payment processing server 30 has the following functions.
Function of issuing a credit card or a virtual prepaid card.
Function of transmitting approval information only when the inquiry amount contained in inquiry information transmitted from a member shop (an administrator of the order receiving server 20) is equal to or less than the available amount of the card number corresponding to a payer related to the inquiry information. The approval information may be transmitted only when the inquiry amount is equal to or less than the available amount and the card number is valid.
Function of changing data corresponding to the card number so that the inquiry amount is reduced from the available amount when the approval information is transmitted.
Function of performing payment processing for paying funds collected from a user corresponding to the card number to a member shop based on sales information from the member shop.

The payment agent server 10 is a computer that executes processing related to a payment agent, and it is administered by a payment agent company. A manager of an online shopping site or a credit company may manage the payment agent server 10.

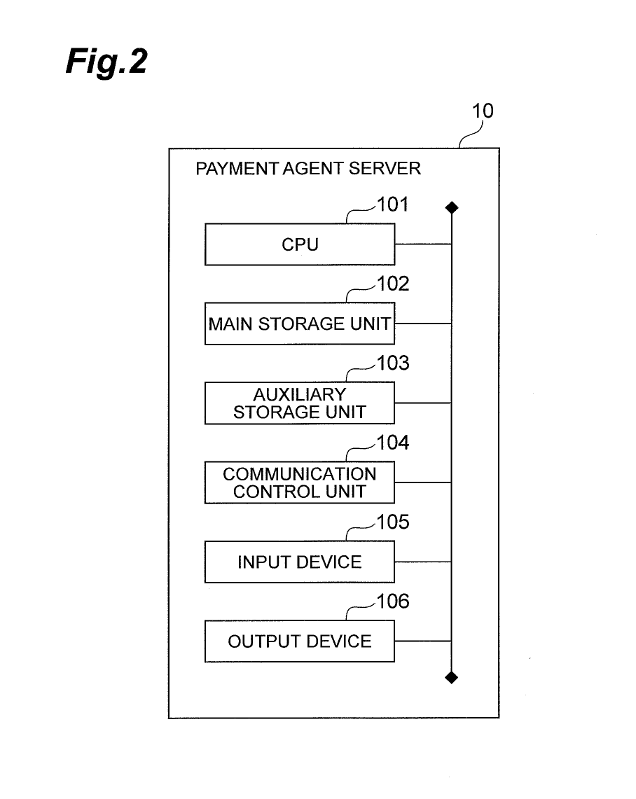

FIG. 2 shows a hardware configuration of the payment agent server 10. The payment agent server 10 includes one or more CPU 101 that executes an operating system, an application program and the like, a main storage unit 102 such as ROM and RAM, an auxiliary storage unit 103 such as a hard disk and a flash memory, a communication control unit 104 such as a network card or a wireless communication module, an input device 105 such as a keyboard and a mouse, and an output device 106 such as a display.

The functional components of the payment agent server 10, which are described later, are implemented by loading given software onto the CPU 101 or the main storage unit 102, making the communication control unit 104, the input device 105, the output device 106 and the like operate under control of the CPU 101, and performing reading and writing of data in the main storage unit 102 or the auxiliary storage unit 103. The data and database required for processing are stored in the main storage unit 102 or the auxiliary storage unit 103.

Although the payment agent server 10 is composed of one computer in the example of FIG. 2, the payment agent server 10 may be composed of a plurality of computers.

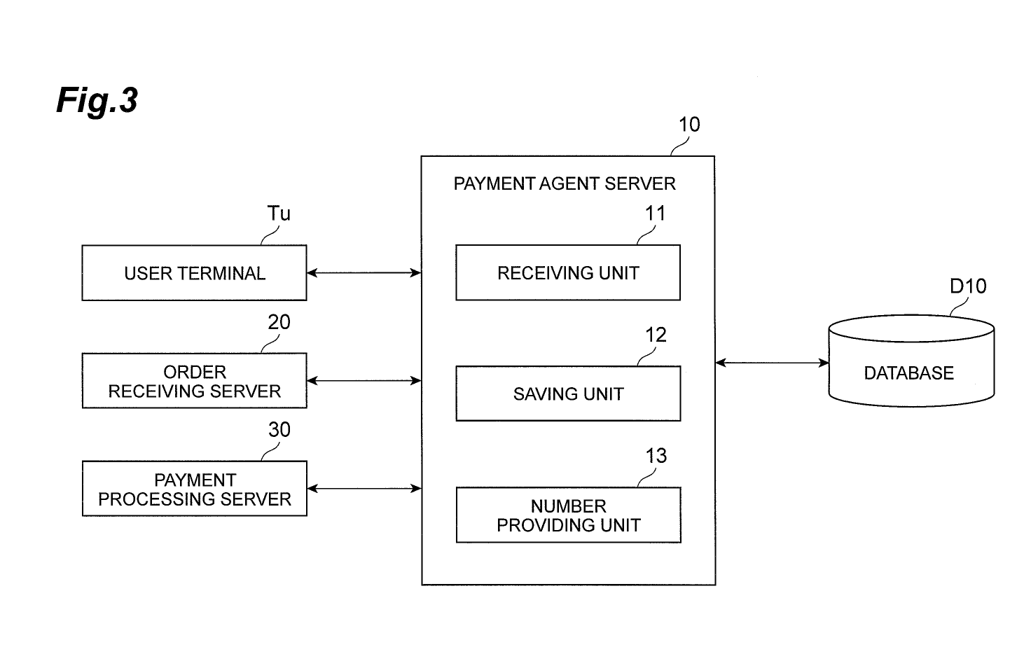

As shown in FIG. 3, the payment agent server 10 includes a receiving unit 11, a saving unit 12, and a number providing unit 13 as functional components. In this invention, the number providing unit 13 can function as a value specifying data providing unit, a first recording unit, an ID information providing unit, a second recording unit, and an acquisition unit.

The receiving unit 11 is a functional element that receives a request for a payment agent from the user terminal Tu. When a user selects a payment agent on the payment page, the user terminal Tu transmits a payment agent request to the payment agent server 10. The payment agent request is a signal that at least contains a payment amount (purchase amount) of a commercial transaction on the online shopping site. The receiving unit 11 outputs the payment amount to the saving unit 12.

The saving unit 12 is a functional element that saves a value equivalent to the payment amount of a commercial transaction. “Saving a value” is processing of storing a certain amount of values (money, points, credit by a credit company etc.) held by a user that is equivalent to a payment to a credit company into a recording medium such as the database D10 to thereby avoid use of the value equivalent to the payment for another payment.

A method for saving is different depending on the type of the value. For example, if the value is money, the saving unit 12 may save the money equivalent to the payment amount by making inquiries to a financial institution server (not shown) about the amount of advance payment made from a user to a financial institution. In this case, the saving unit 12 transmits an inquiry signal containing a receipt number related to the payment agent request to the financial institution server and receives data of the amount of advance payment corresponding to the receipt number from the financial institution server.

If the value is points, the saving unit 12 may save the points equivalent to the payment amount by accessing a point database that stores points of each user. At this time, the saving unit 12 may convert points into money using a conversion rate. Note that the database D10 may serve also as the point database. In this case, the saving unit 12 acquires points of the user by reading point data corresponding to the user ID from the point database.

If the value is credit by a credit company, the saving unit 12 sends a notification to guarantee payment of the price of a payment agent with a credit card of the user to the credit company to the payment processing server 30 and acquires credit for the guarantee from the payment processing server 30.

In this manner, although there are various methods of saving the value, the saving unit 12 outputs the saved value to the number providing unit 13 in any case.

The number providing unit 13 is a functional element that provides card information required for credit payment. The card information contains a card number and attached information of a virtual prepaid card, and the attached information contains an expiration date and a security code. The card number of the virtual prepaid card is ID information in the same format as a credit card, and it is the number that can be used within the range of the limit amount. In this embodiment, the card number can be used only once. For the card number, the value saved by the saving unit 12 is set as the limit amount. Thus, in this embodiment, the card number is value specifying data.

The number providing unit 13 generates an issuance request containing the saved value and transmits it to the payment processing server 30. In response to the request, the payment processing server 30 assigns one card number and sets an expiration date, a security code and a use limit for the card number. Further, the payment processing server 30 transmits the card number and the attached information (the expiration date and the security code) as card information to the payment agent server 10. Furthermore, the payment processing server 30 stores the card information with which the use limit is further associated into the database D30.

The number providing unit 13 stores the received card information in association with the saved value into the database D10 and transmits the card information to the user terminal Tu. The user terminal Tu receives the card information and sets it to the entry field on the payment page. Because the card information is inserted automatically in this manner, a user skips entry of the card information and performs an operation to fix the payment. The payment operation and the subsequent processing (for example, processing from confirmation of the entered information to notification of the order completion) are the same as those in the existing purchase processing using a credit card.

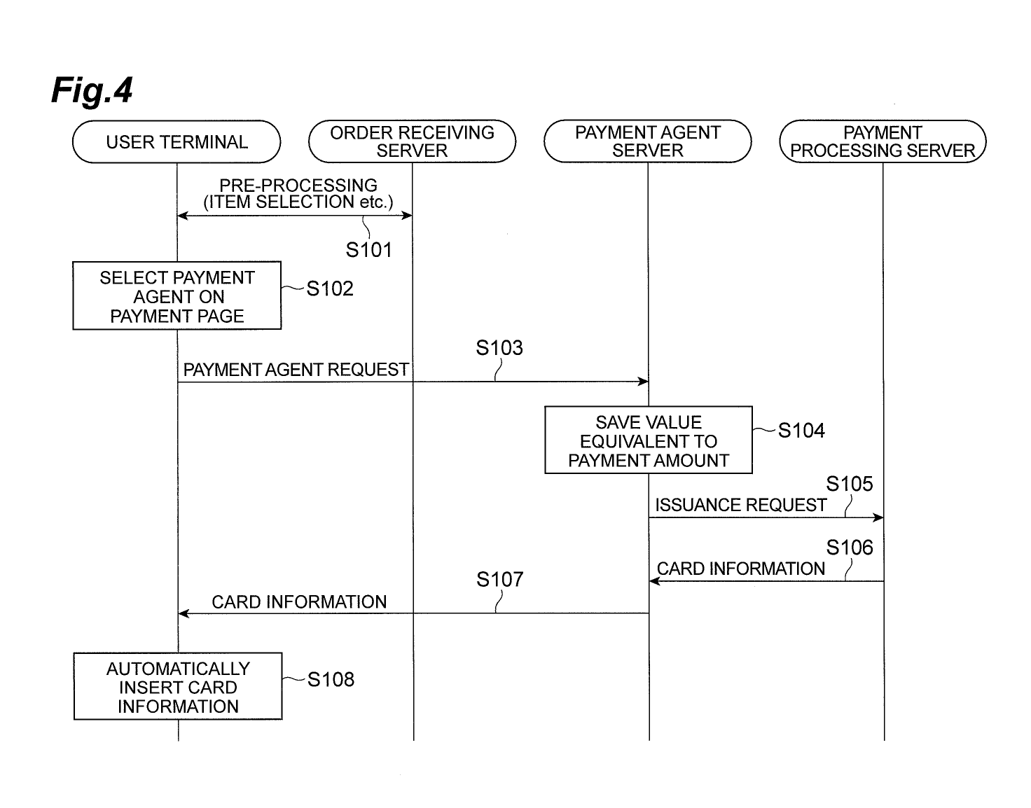

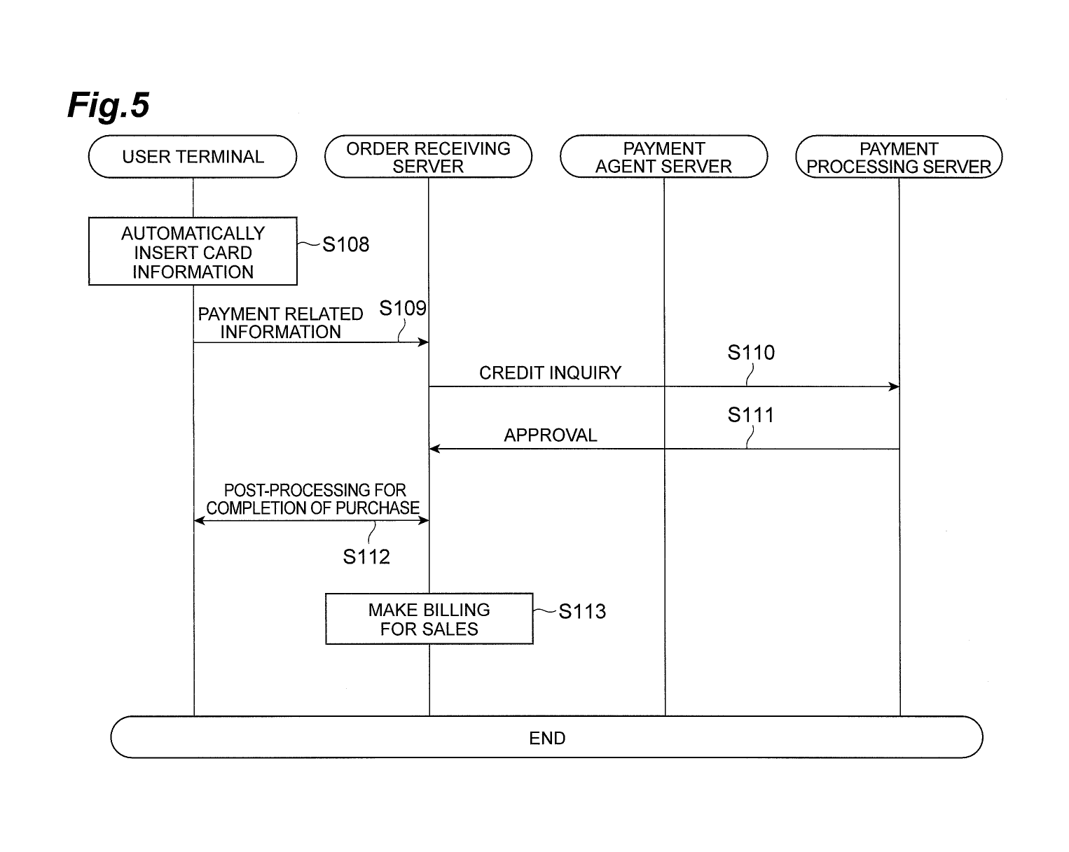

The operation of the EC system 1 is described and further an information processing method according to this embodiment is described hereinafter with reference to FIGS. 4 and 5.

In response to a user operation on the online shopping site, pre-processing such as item search and item selection is performed between the user terminal Tu and the order receiving server 20 (Step S101), and when the user selects a payment agent on the payment page (Step S102), the user terminal Tu transmits a payment agent request to the payment agent server 10 (Step S103).

In the payment agent server 10, the receiving unit 11 receives the payment agent request, and the saving unit 12 saves the value equivalent to the payment amount indicated by the application (Step S104, saving step). Then, the number providing unit 13 transmits an issuance request to the payment processing server 30 (Step S105) and receives card information (a card number and attached information) transmitted from the payment processing server 30 in response to the request (Step S106). In relation to those Steps S105 and S106, the number providing unit 13 and the payment processing server 30 store the card information into the databases D10 and D30, respectively.

Then, the number providing unit 13 transmits the card information to the user terminal Tu (Step S107, value specifying data providing step), and the user terminal Tu inserts the card information into the entry field of the payment page (Step S108).

Processing after information of a virtual prepaid card is automatically inserted into the payment page is the same as the existing one. Specifically, the user terminal Tu transmits the card information as payment related information to the order receiving server 20 (Step S109). Thus, in this embodiment, the payment agent server 10 provides the card number (ID information) to the order receiving server 20 through the user terminal Tu. After that, the order receiving server 20 makes a credit inquiry to the payment processing server 30 based on the information (Step S110), and the payment processing server 30 makes approval for the inquiry (Step S111).

When the use of the virtual prepaid card is approved, the user terminal Tu and the order receiving server 20 work together to execute post-processing for completing the purchase (display of a confirmation page, processing for order fixing etc.) (Step S112). The purchase processing thereby ends. After that, the order receiving server 20 executes processing related to billing for sales using the acquired card information (Step S113).

As described above, according to this embodiment, because the value equivalent to the payment amount of a commercial transaction is saved, a provider of the payment service (payment agent company) can pay the saved value to the administrator of the online shopping site through the credit company. Accordingly, in the settlement service (payment agent service) that receives money to be paid from a user to a shop from the user and pays it to the shop, it is possible to reduce the risk on the service provider.

The administrator of the order receiving server 20 needs to modify the online shopping site so that a user can select a payment agent. However, this modification is easy, just adding a code for referring to a source file of JavaScript (trademark or registered trademark) into HTML source file. Thus, the administrator of the order receiving server 20 can adopt the mechanism of the present invention by making the simple modification.

### Second Embodiment

A second embodiment is different from the first embodiment in not presenting information (card information) of a virtual prepaid card to a user. Differences from the first embodiment are particularly described below.

In this embodiment, the number providing unit 13 generates dummy card information (which is referred to hereinafter as “dummy information”) to be presented to a user. The dummy information contains a dummy card number (dummy number) and dummy attached information. The dummy number is a number in the same format as a credit card number and a different number from a virtual prepaid card number. The number providing unit 13 may assign the dummy number and the attached information for each commercial transaction. Alternatively, the number providing unit 13 may use the dummy number assigned for each order receiving server 20 and set the attached information for each commercial transaction. In this case, because each order receiving server 20 can use the dummy number assigned in a fixed manner more than once, processing of using the dummy information is facilitated.

Then, the number providing unit 13 transmits the dummy information to the user terminal Tu in response to the payment agent request. Further, the number providing unit 13 acquires information of the virtual prepaid card in the same manner as in the first embodiment. Specifically, the number providing unit 13 generates an issuance request that contains the saved value and the dummy information and transmits it to the payment processing server 30. The issuance request is used also to cause the payment processing server 30 to store the dummy information. The payment processing server 30 generates the card information in the same manner as in the first embodiment and stores the card information in association with the dummy information into the database D30. Further, the payment processing server 30 transmits the card information to the payment agent server 10. The number providing unit 13 receives the card information and stores the saved value, the dummy information and the card information in association with one another into the database D10. Thus, the dummy number is value specifying data in this embodiment.

The user terminal Tu receives the dummy information transmitted from the number providing unit 13 and sets it to the entry field on the payment page. When the dummy information is automatically inserted in this manner, the user performs an operation to fix the payment. In response to this operation, processing for completing a purchase procedure (for example, processing from confirmation of the entered information to notification of the order completion) is executed between the user terminal Tu and the order receiving server 20. During this processing, the order receiving server 20 makes a credit inquiry to the payment processing server 30 using the dummy information.

The order receiving server 20 transmits the dummy information to the payment agent server 10 at arbitrary timing after the purchase procedure is completed. The number providing unit 13 reads the card information corresponding to the dummy information from the database D10 and transmits it to the order receiving server 20. The order receiving server 20 makes a credit inquiry to the payment processing server 30 using the card information and then performs billing for sales containing the current payment amount.

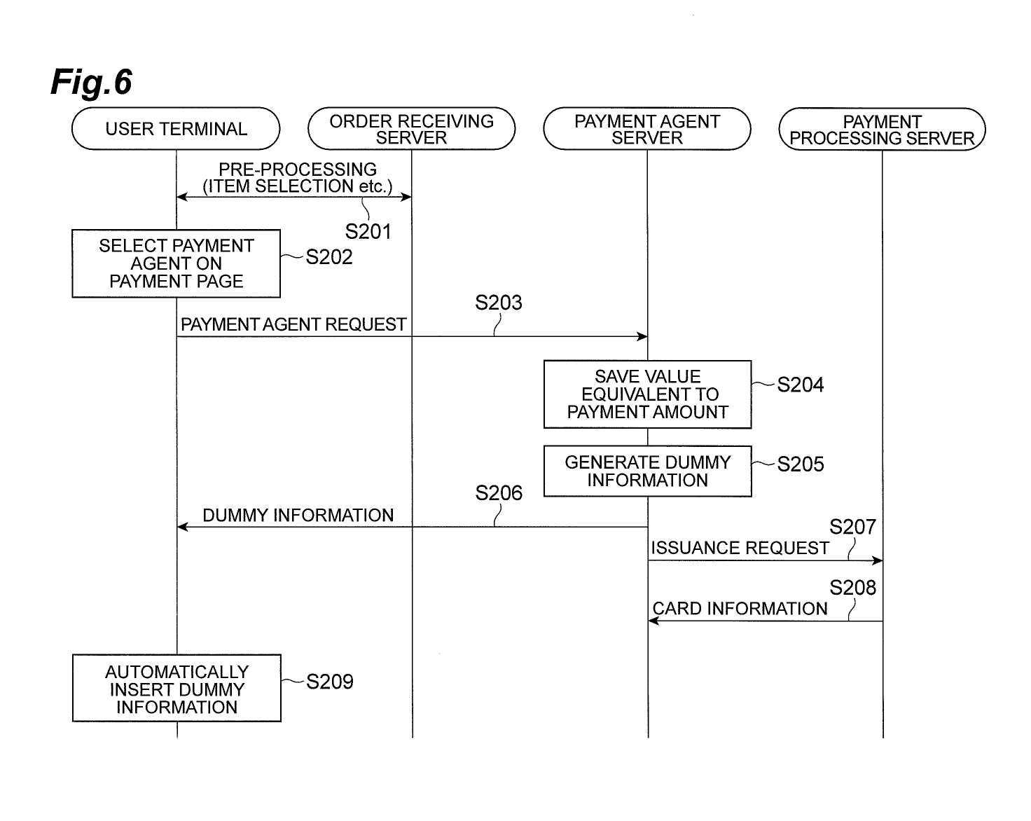

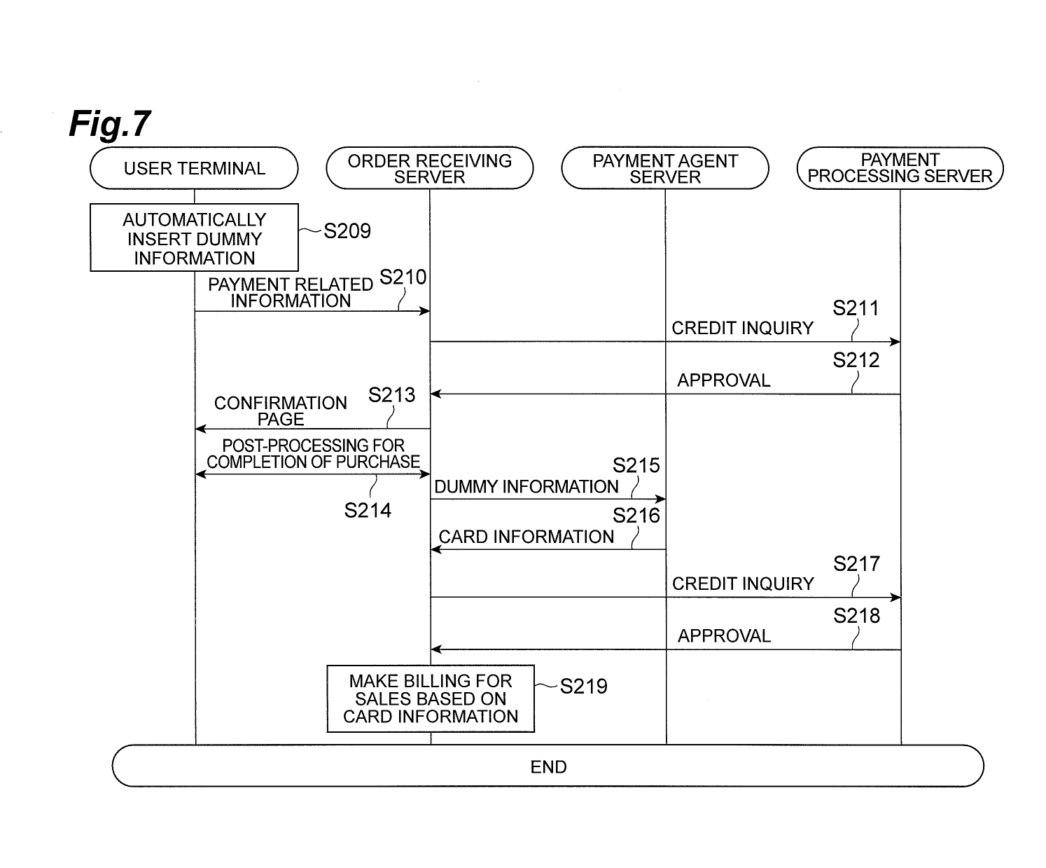

The operation of the EC system 1 is described and further an information processing method according to this embodiment is described hereinafter with reference to FIGS. 6 and 7.

Processing of Steps S201 to S204 is the same as the processing in Steps S101 to S104 in the first embodiment. Then, the number providing unit 13 generates dummy information and transmits it to the user terminal Tu (Step S205, S206, value specifying data providing step).

Further, the number providing unit 13 transmits an issuance request to the payment processing server 30 (Step S207) and receives card information (a card number and attached information) transmitted from the payment processing server 30 in response to the request (Step S208). In relation to the processing of those Steps S206 and S207, the number providing unit 13 and the payment processing server 30 store the dummy information and the card information in association with each other into the databases D10 and D30, respectively.

The user terminal Tu inserts the dummy information received from the payment agent server 10 into the entry field of the payment page (Step S209). Then, in response to a user operation, the user terminal Tu transmits the dummy information as payment related information to the order receiving server 20 (Step S210). Thus, in this embodiment, the payment agent server 10 provides the dummy number to the order receiving server 20 through the user terminal Tu.

After that, the order receiving server 20 makes a credit inquiry to the payment processing server 30 based on the dummy information (Step S211), and the payment processing server 30 makes approval for the inquiry (Step S212). Then, the order receiving server 20 transmits a confirmation page for confirming the payment procedure to the user terminal Tu (Step S213). After that, the user terminal Tu and the order receiving server 20 work together to execute the remaining processing (processing for order fixing etc.) (Step S214), and the purchase processing thereby ends.

After that, the order receiving server 20 transmits the dummy information to the payment agent server 10 and thereby acquires the card information (Steps S215 and S216) and then makes a credit inquiry to the payment processing server 30 using the card information (Step S217). When the payment processing server 30 makes approval for the inquiry (Step S218), the order receiving server 20 executes processing related to billing for sales using the card information (Step S219).

In this embodiment, the number providing unit 13 may acquire the card information from the payment processing server 30 after receiving the dummy information from the order receiving server 20. This means that the processing in Steps S207 and S208 is performed between Steps S215 and S216. In this case, because the time to store the card information in the payment processing server 30 becomes shorter as the processing to generate the card information is performed later, it is possible to reduce the risk on a payment agent company that makes payment based on the card information.

As described above, in this embodiment also, in a payment service that receives money to be paid from a user to a shop from the user and pays it to the shop, it is possible to reduce the risk on the service provider (payment agent company).

Although the administrator of the online shopping site needs to modify the online shopping site and implement processing of converting dummy information into card information before billing for sales, the modification is relatively easy.

In addition, because the payment agent server 10 does not transmit information of the virtual prepaid card to the user terminal in this embodiment, it is possible to further reduce the risk that the payment agent company suffers an accidental loss. Further, the card number is reusable in the server.

Because information of the virtual prepaid card is not provided to a user in this embodiment, it is less probable that the user uses the card information for another commercial transaction. Therefore, credit inquiries (Steps S211, S212, S217 and S218) can be omitted in this embodiment.

### Third Embodiment

Although a third embodiment is the same as the second embodiment in that payment is done without presenting information (card information) of the virtual prepaid card to a user, the payment agent server 10 does not provide the dummy information to the user. In this embodiment, the payment agent server 10 gives a notification that the value equivalent to the payment amount is saved to the order receiving server 20 through the user terminal Tu, and the order receiving server 20 completes the purchase procedure, trusting the notification. Differences from the first embodiment are particularly described below.

In this embodiment, when the saving unit 12 saves the value equivalent to the payment amount in the same manner as in the first embodiment, it sends a message indicating approval of a payment agent to the user terminal Tu as a response to a payment agent request. This message is payment status information indicating that the value is saved and payment for a commercial transaction is done, and this corresponds to value specifying data in this embodiment.

In this embodiment, the HTTP session related to the online shopping site includes a payment flag indicating whether payment is done or not. The user terminal Tu has the payment flag in a storage unit inside the terminal using a scheme such as HTTP Cookie and changes the payment flag from unpaid (OFF) to paid (ON) based on the received message. In this processing, the user terminal Tu may write encryption data provided from the payment agent server 10, together with a payment completion flag, into the storage unit inside the terminal. The encryption data may be a value obtained by converting ID of a payment agent company and a receipt number of a payment agent service into a hash value. Changing the flag corresponds to storing the payment status information by the user terminal Tu. Further, the user terminal Tu disables the card information entry field in the payment page.

After the entry field is disabled, the user performs an operation to fix the purchase. The order receiving server 20 receives the payment flag set to “ON” and then executes the remaining processing (for example, processing from confirmation of the entered information to notification of the order completion) and ends the purchase procedure without communicating with the payment processing server 30.

The number providing unit 13 acquires information of the virtual prepaid card in the same manner as in the first embodiment. Specifically, the number providing unit 13 generates an issuance request that contains the saved value and transmits it to the payment processing server 30, and stores the card information transmitted from the payment processing server 30 in response to the request into the database D10. During this processing, the payment processing server 30 stores the card information into the database D30 in the same manner as in the first embodiment.

The order receiving server 20 requests the card information to the payment agent server 10 at arbitrary timing after the purchase procedure is done. In response to the request, the number providing unit 13 transmits the card information to the order receiving server 20. The order receiving server 20 uses the card information and performs billing for sales containing the payment amount after that.

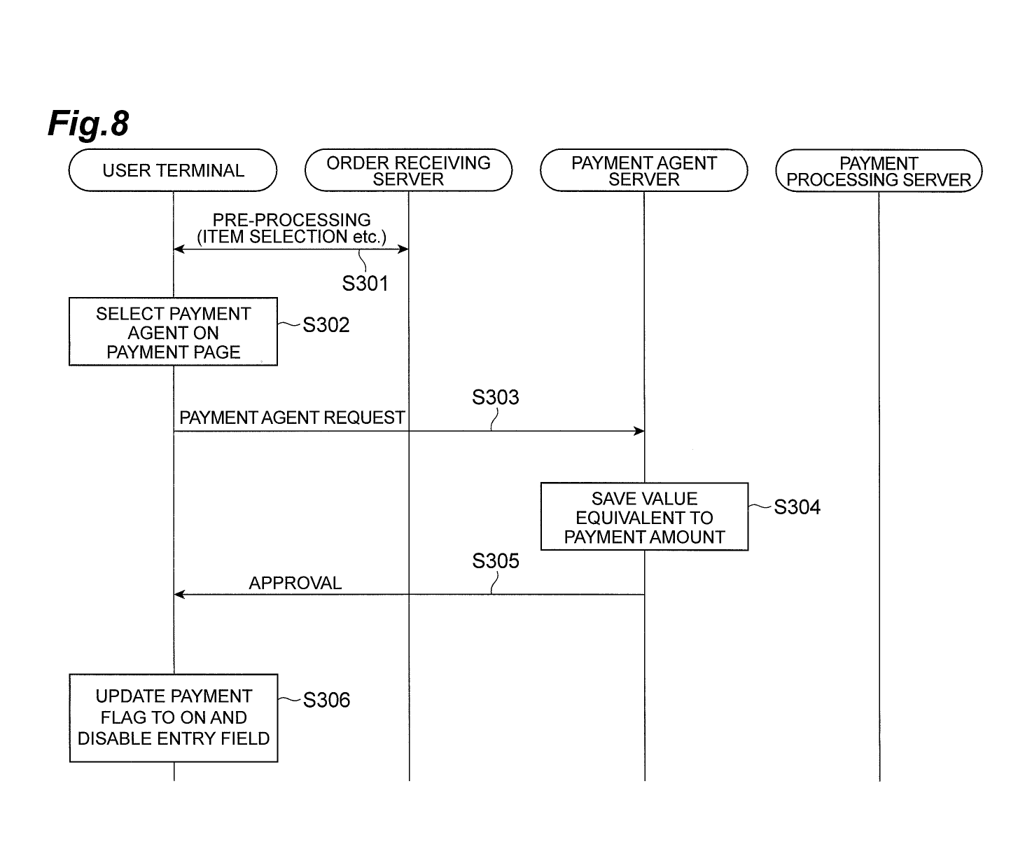

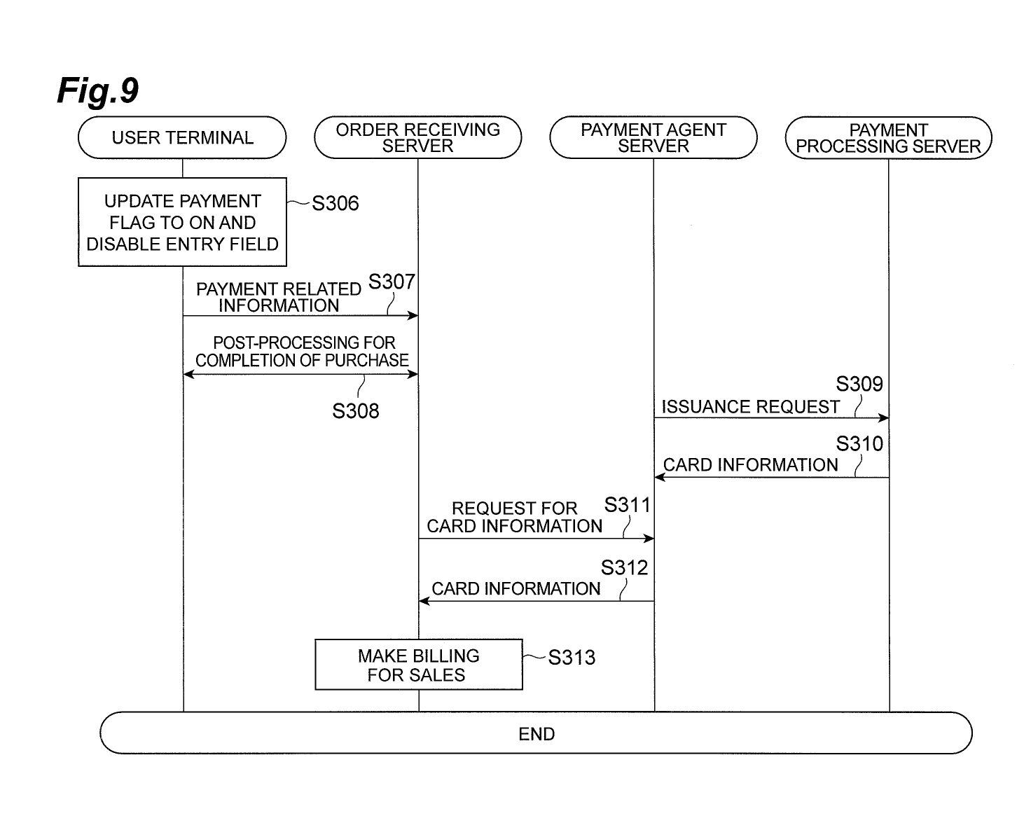

The operation of the EC system 1 is described and further an information processing method according to this embodiment is described hereinafter with reference to FIGS. 8 and 9.

Processing of Steps S301 to S304 is the same as the processing in Steps S101 to S104 in the first embodiment. Then, the saving unit 12 sends a message indicating approval of payment for a payment agent request to the user terminal Tu (Step S305, value specifying data providing step).

The user terminal Tu receives the message and updates the payment flag in the HTTP session from “OFF” to “ON” (in other words, make the payment flag significant) and disables the entry field of the card information (Step S306). At this time, the user terminal Tu may store the encryption data. Then, the user terminal Tu transmits payment related information containing the updated payment flag (the payment related information may contain the encryption data) to the order receiving server 20 in response to a user operation (Step S307).

Receiving the payment information, the order receiving server 20 works together with the user terminal Tu to execute the remaining processing (processing for order fixing etc.) (Step S308), and the purchase processing thereby ends. The order receiving server 20 may confirm that the value is saved by transmitting the encryption data to the payment agent server 10 between Steps S307 and S308.

On the other hand, in the payment agent server 10, the number providing unit 13 transmits an issuance request to the payment processing server 30 (Step S309) and receives card information (a card number and attached information) transmitted from the payment processing server 30 in response to the request (Step S310). After that, in response to a request from the order receiving server 20 that has completed the purchase procedure, the number providing unit 13 transmits the card information to the order receiving server 20 (Steps S311 and S312). Then, the order receiving server 20 performs billing for sales based on the card information (Step S313).

Because information of the virtual prepaid card is not provided to a user in this embodiment, it is less probable that the user uses the card information for another commercial transaction. Therefore, credit inquiries are not made in this embodiment.

In this embodiment, the number providing unit 13 may acquire the card information from the payment processing server 30 after receiving the card information from the order receiving server 20. This means that the processing in Steps S309 and S310 is performed between Steps S311 and S312. In this case, because the time to store the card information in the payment processing server 30 becomes shorter as the processing to generate the card information is performed later, it is possible to reduce the risk on a payment agent company that makes payment based on the card information.

As described above, in this embodiment also, in a payment service that receives money to be paid from a user to a shop from the user and pays it to the shop, it is possible to reduce the risk on the service provider (payment agent company). Further, the administrator of the online shopping site can adopt the mechanism of the present invention by making a simple modification to the online shopping site in the same manner as in the first embodiment.

In addition, because the payment agent server 10 does not transmit information of the virtual prepaid card to the user terminal in this embodiment also, it is possible to further reduce the risk on the payment agent company. Further, the card number is reusable in the server.

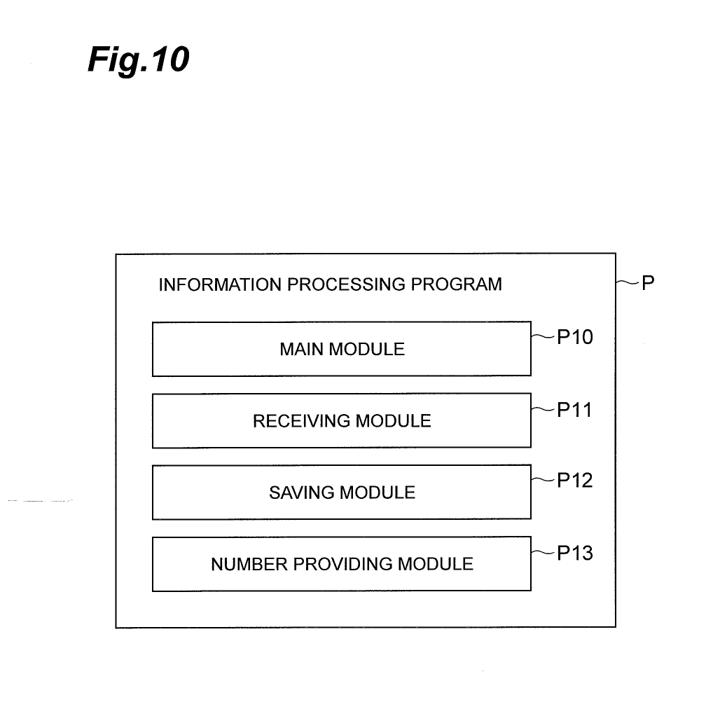

An information processing program P that causes a computer to function as the payment agent server 10 according to the first to third embodiments is described hereinafter with reference to FIG. 10.

The information processing program P includes a main module P10, a receiving module P11, a saving module P12 and a number providing module P13.

The main module P10 is a part that exercises control over the payment agent. The functions implemented by executing the main module P10, the receiving module P11, the saving module P12 and the number providing module P13 are equal to the functions of the receiving unit 11, the saving unit 12 and the number providing unit 13 described above, respectively.

The information processing program P is provided in the form of being recorded in a static manner on a tangible recording medium such as CD-ROM or DVD-ROM or semiconductor memory, for example. Further, the information processing program may be provided as a data signal superimposed onto a carrier wave through a communication network.

Hereinbefore, the present invention has been described in detail with respect to the embodiment thereof. However, the present invention is not limited to the above-described embodiment. Various changes and modifications may be made therein without departing from the scope of the invention.

### REFERENCE SIGNS LIST

1 . . . electronic commerce system, 10 . . . payment agent server, 11 . . . receiving unit, 12 . . . saving unit, 13 . . . number providing unit (value specifying data providing unit, first recording unit, ID information providing unit, second recording unit, and acquisition unit), 20 . . . order receiving server, 30 . . . payment processing server, D10, D20, D30 . . . databases, P . . . information processing program, P10 . . . main module, P11 . . . receiving module, P12 . . . saving module, P13 . . . number providing module

1-11. (canceled)

12. An information processing apparatus comprising:
a saving unit configured to, in response to receiving a request for a payment agent in a commercial transaction from a terminal of a user not having a credit card, save available points of the user equivalent to a payment amount of the commercial transaction from a point storage unit; and
a providing unit configured to acquire a card number of a prepaid payment means usable like a credit card and set a limit amount based on the available points saved by the saving unit, and thereby provide card information of the prepaid payment means containing the card number and the limit amount for payment of the commercial transaction.

13. The information processing apparatus according to claim 12, wherein
the card number is usable only once.

14. The information processing apparatus according to claim 12, wherein
the providing unit transmits the card information to the terminal for payment of the commercial transaction.

15. The information processing apparatus according to claim 12, wherein
the providing unit generates dummy information different from the card information, transmits the dummy information to the terminal without transmitting the card information, and, in response to a request from an order receiving processing device having received the dummy information from the terminal in the commercial transaction, provides the card information corresponding to the dummy information to the order receiving processing device.

16. The information processing apparatus according to claim 12, wherein
the saving unit transmits payment status information indicating that the points are saved to the terminal, and
in response to a request from an order receiving processing device having received the payment status information from the terminal in the commercial transaction, the providing unit provides the card information corresponding to the payment status information to the order receiving processing device.

17. An information processing method performed by an information processing apparatus including a processor, comprising:
a saving step of, in response to receiving a request for a payment agent in a commercial transaction from a terminal of a user not having a credit card, saving available points of the user equivalent to a payment amount of the commercial transaction from a point storage unit; and
a providing step of acquiring a card number of a prepaid payment means usable like a credit card and setting a limit amount based on the available points saved in the saving step, and thereby providing card information of the prepaid payment means containing the card number and the limit amount for payment of the commercial transaction.
